(19) United States
(12) Patent Application Publication
(10) Pub. No.: US 2026/0310882 A1
(43) Pub. Date: Oct. 8, 2026

(54) METHOD OF GENERATING REGULATORY OUTPUTS

(71) Applicant: Albert Invent Corporation, Oakland, CA (US)

(72) Inventors: Nick Talken, Oakland, CA (US); Neelesh Vaikhary, Oakland, CA (US); Mukund Jangid, Oakland, CA (US); Danish Ahmed, Oakland, CA (US); Mary Lucas, Oakland, CA (US); Shashank Agrawal, Oakland, CA (US); Ben El Darragi, Oakland, CA (US); Trent Duncan, Oakland, CA (US)

(73) Assignee: Albert Invent Corporation, Oakland, CA (US)

(21) Appl. No.: 19/482,089

(22) PCT Filed: May 9, 2024
(86) PCT No.: PCT/US2024/028633

§ 371 Date: Nov. 6, 2025

Related U.S. Application Data
(60) Provisional application No. 63/501,242, filed on May 10, 2023.

(51) Int. Cl. G06F 40/166; G06F 40/117; G06F 40/197

(52) U.S. Cl. CPC G06F 40/166; G06F 40/117; G06F 40/197

(57) ABSTRACT

A method for generating a regulatory output for chemicals, including inputting one or more identifiers of one or more individual chemicals into an algorithm, inputting one or more concentrations of one or more individual chemicals into the algorithm, enriching properties of the one or more individual chemicals by obtaining properties of the one or more individual chemicals from at least one data source to generate enriched properties, evaluating the enriched properties of the one or more individual chemicals to generate representative properties of the one or more individual chemicals by applying predefined steps of the algorithm, and generating the regulatory output of the composite material based on the representative properties of the one or more individual chemicals.

### CROSS-REFERENCE TO RELATED APPLICATION

This application claims the benefit of U.S. Provisional Application No. 63/501,242, filed May 10, 2023; the entire disclosure of which is hereby incorporated by reference.

### BACKGROUND

Regulatory outputs, such as safety data sheets (SDS) can contain critical information including hazards, toxicology, shipping information, protective measures, safety precautions, sustainability information and additional data that define important qualities of chemicals, compositions, and hazardous articles. This information provides guidance to help workers who handle chemicals. Many regulatory authorities require such regulatory outputs to be readily accessible to employees who work with chemicals and chemical compositions.

Specifically, the chemical industry has a massive data leak problem. A lot of documents, and data, including regulatory information, are scattered around workplaces in file cabinets, local computers, and notebooks or are difficult to get from other organizations in the supply chain. Much of the power and value of this information is lost when it can only be accessed by specific labs, chemists, or employees. Further, generating regulatory outputs for chemicals, including proprietary compositions, takes time and money to properly accomplish. Many regulatory authorities and workplaces have different requirements and preferences, both to stay compliant with the law, and to provide accessible information to the workforce. Additionally, the moment a document is created, it is static and quickly becomes outdated or incorrect, as regulations change, new data is collected, or new rules are established.

Accordingly, methods for automatically generating regulatory outputs, including regulatory outputs, that are informed by regulatory requirements and user preference, are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, disclosed herein is a method for generating a regulatory output for chemicals or chemical composition and/or mixtures, the method includes inputting one or more identifiers of one or more individual chemicals into an algorithm, inputting one or more concentrations of one or more individual chemicals into the algorithm, enriching properties of the one or more individual chemicals by obtaining properties of the one or more individual chemicals from at least one data source to generate enriched properties, evaluating the enriched properties of the one or more individual chemicals to generate representative properties of the one or more individual chemicals by applying predefined steps of the algorithm, and generating the regulatory output of the composite material based on the representative properties of the one or more individual chemicals.

In another aspect, disclosed herein is a non-transitory computer readable storage medium storing instructions that, when executed by one or more computers, cause the one or more computers to receive one or more identifiers of one or more individual chemicals, receive one or more concentrations of one or more individual chemicals into an algorithm; enrich properties of the one or more individual chemicals by obtaining properties of the one or more individual chemicals from at least one data source to generate enriched properties, evaluate the enriched properties of the one or more individual chemicals to define representative properties of the one or more individual chemicals by applying the predefined steps of the algorithm, and define a regulatory output of the one or more individual chemicals based on the representative properties.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is an example regulatory output, in accordance with the present technology;

FIG. 1B is a portion of the example regulatory output of FIG. 1A, in accordance with the present technology;

FIG. 1C is another portion of the example regulatory output of FIG. 1A, in accordance with the present technology;

FIG. 1D is another portion of the example regulatory output of FIG. 1A, in accordance with the present technology;

FIG. 2 is an example software architecture for carrying out the methods disclosed herein, in accordance with the present technology;

FIG. 3A is a regulatory output with an example explanation, in accordance with the present technology;

FIG. 3B is a regulatory output with another example explanation, in accordance with the present technology;

FIG. 4 is an example method of generating a regulatory output, in accordance with the present technology;

FIG. 5 is another example method of generating a regulatory output, in accordance with the present technology;

FIG. 6 is an example method of generating and updating a regulatory output, in accordance with the present technology;

FIG. 7 is another example method of generating and updating a regulatory output, in accordance with the present technology;

FIG. 8 is another example method of generating a regulatory output, in accordance with the present technology;

FIG. 9 is an example method of analyzing interactions of properties to define a regulatory output, in accordance with the present technology;

FIG. 10 is an example method of generating multiple versions of a regulatory output, in accordance with the present technology;

FIG. 11 is an example method of generating a regulatory output with a hierarchy of rules, in accordance with the present technology; and

FIG. 12 is another example method of generating a regulatory output, in accordance with the present technology.

### DETAILED DESCRIPTION

While illustrative embodiments have been illustrated and described, it will be appreciated that various changes can be made therein without departing from the spirit and scope of the invention.

Described herein is a method for generating a regulatory output (e.g., a safety data sheet, a label, a sticker, a dossier, a notification, a digital submission, a registration, a certificate, a webpage, or the like). In some embodiments, the method includes inputting an identifier and a concentration of a chemical. In some embodiments, properties of the chemical (e.g., boiling point, melting point, toxicology, and the like) are enriched by obtaining properties of the chemical from at least one data source to generate enriched properties. In some embodiments, the enriched properties are then evaluated to generate representative properties of the chemical by applying predefined steps of an algorithm. In such embodiments, enriching the properties may include comparing properties from multiple sources to ensure the properties are correct, analyzing interactions between the properties to generate additional properties, applying rules of a tenant (e.g., user), or applying rules of a regulatory authority (e.g., a country, agency, or the like). In some embodiments, the regulatory authority is the Globally Harmonized System (GHS) or specific revisions of GHS or government bodies such as OSHA, DOT or a local agency such as OEHHA in California. In some embodiments a regulatory authority is a private company like Nike (Restricted Substance List). In some embodiments a regulatory authority is a combination or coalition of private companies (National Association of Printing Ink Manufacturers), a non-profit or any other type of non-governmental organization like The Living Future Institute (https://living-future.org/red-list/). In some embodiments, the method further includes generating the regulatory output of the one or more chemicals based on the representative properties of the one or more chemicals.

Also disclosed herein is a non-transitory computer readable storage medium, storing instructions that, when executed by one or more computers, implement the methods described herein. In some embodiments, the instructions cause the one or more computers to receive the identifier and concentration of the one or more individual chemicals, enrich the properties of the one or more individual chemicals by obtaining properties of the one or more individual chemicals from at least one data source, and evaluate the enriched properties to define representative properties of the one or more individual chemicals. For example, if the individual chemicals input represent the constituent chemicals of epoxy resin, enriching the properties may include determining a chemical identifier of the combination of the one or more individual chemicals (such as an International Union of Pure and Applied Chemistry (IUPAC) name, like prop-2-enoic acid in the case of epoxy resin), determining a chemical structure of the one or more individual chemicals, any hazards of the one or more individual chemicals (such as skin irritation in the case of epoxy resin), determining a structure of the resulting chemical (in this case, epoxy resin or prop-2-enoic acid), and the like. In such embodiments, enriched properties include chemical properties, hazards, storage requirements, reporting requirements, and the like. In some embodiments, the instructions further cause one or more computers to define a regulatory output of the one or more individual chemicals.

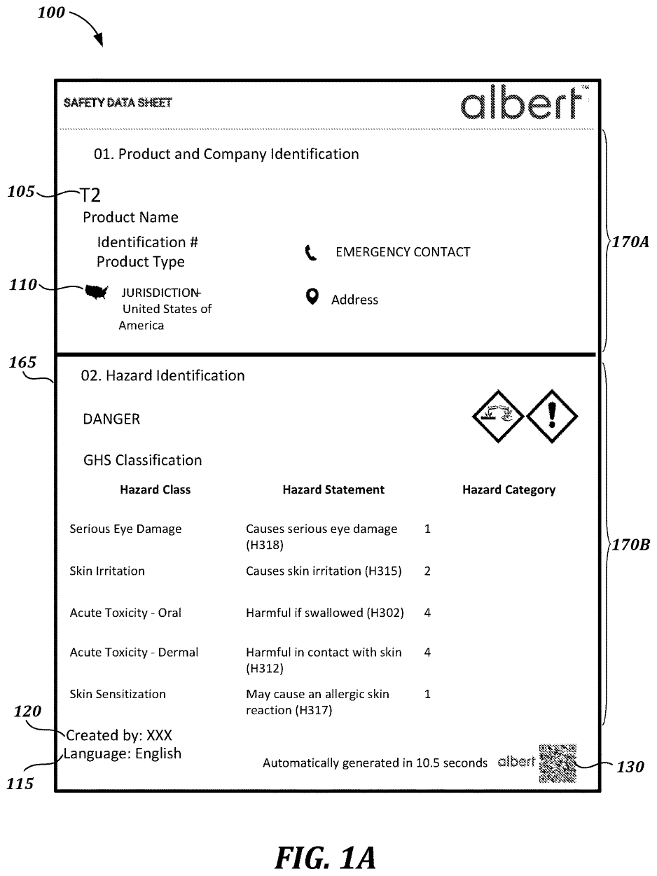

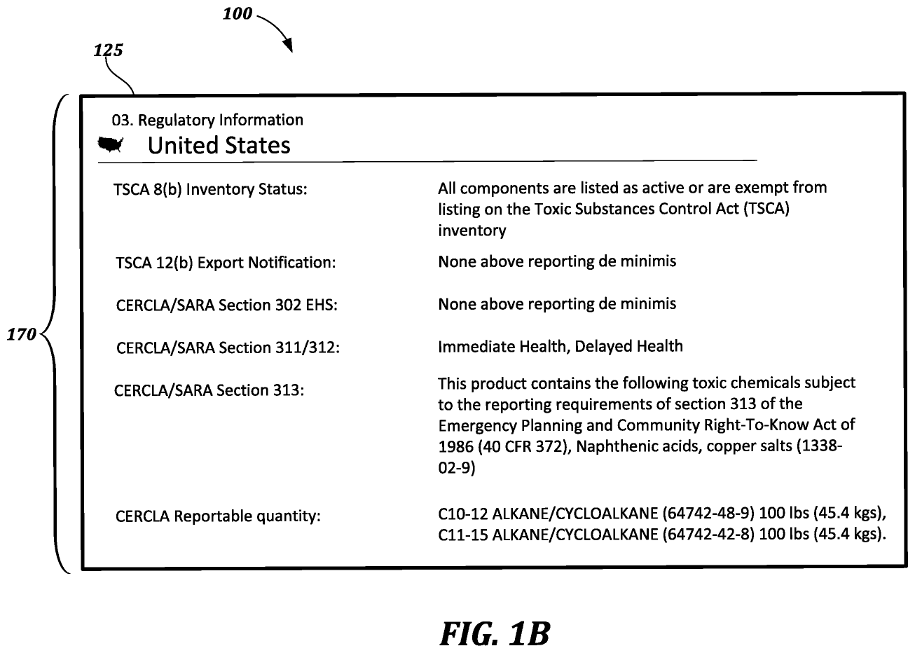

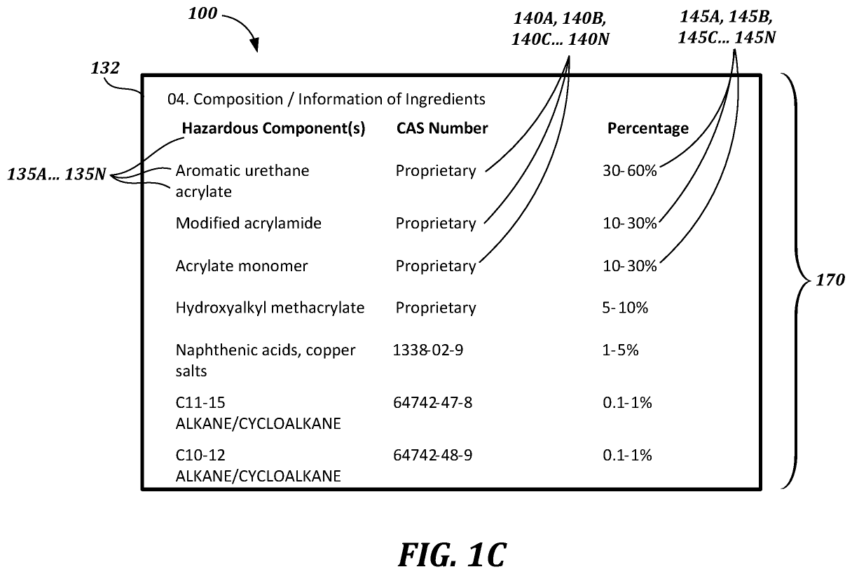

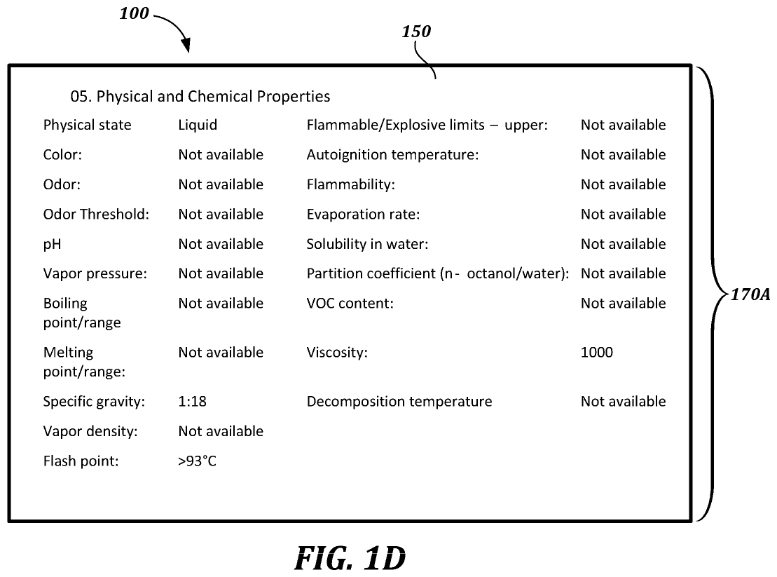

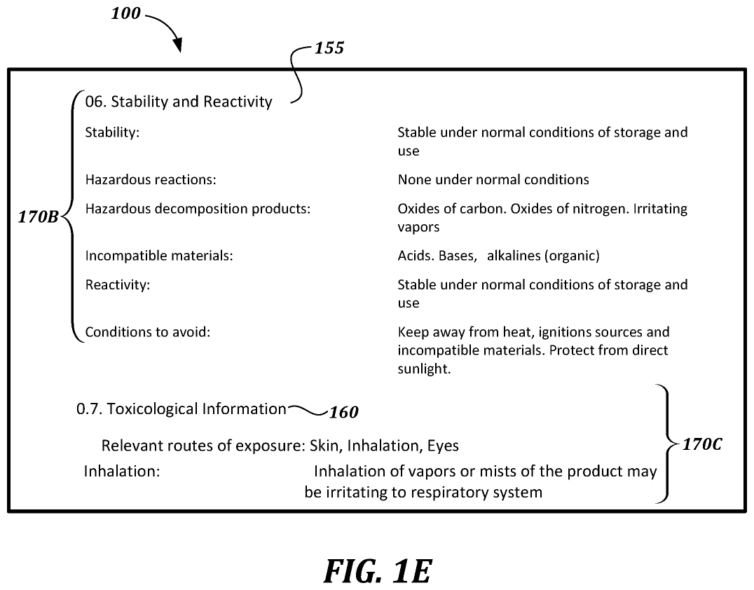

Turning now to the figures, FIG. 1A is an example regulatory output, in accordance with the present technology. In some embodiments, the regulatory output 100 includes a cover sheet. The regulatory output 100 may be physical or digital. In some embodiments, the regulatory output 100 is a safety data sheet (SDS). In some embodiments, the regulatory output 100 is a label (such as a shipping label) or a sticker. In some embodiments, the regulatory output 100 is a webpage, dossier, or certificate. In some embodiments, the regulatory output 100 is a dynamic webpage. In some embodiment, the output is a sustainability certificate. As described herein, a dynamic webpage may be any web page whose construction is controlled by at least one application server processing server-side or client-side script. In some embodiments, the dynamic webpage displays different content for different tenants while retaining the same layout and/or design. In some embodiments, the different content is determined by the tenant themselves, the time of day, the time zone, IP address, physical location, the tenant's native language, and the like.

In some embodiments, the regulatory output 100 is controlled by a tenant. As used herein, a tenant is an organization that dictates rules of the regulatory output 100, such as a lab, a firm, a school, or a business. In some embodiments, a user (also referred to as a creator) generates the regulatory output 100. The user (or creator) may be a member of the tenant. In the case that the tenant includes only a single user, the user and the tenant are the same.

In some embodiments, product information 105 includes an identifier, manufacturer, and type of product. In some embodiments, the product is one or more individual chemicals. In some embodiments, these chemicals have an unknown exact chemical structure, and are fully defined by their properties. In some embodiments, the product is a composite material (i.e., a material made up of one or more individual chemicals). In some embodiments, the composite contains impurities. In some embodiments, the product is a liquid, gas, solid, aerosol, emulsion, aqueous solution, suspension, gel, or foam. In some embodiments, the product information may be input by a tenant of the method. In some embodiments, the product information may be generated by an algorithm, such as when a tenant or user inputs two or more chemical identifiers and concentrations. In some embodiments, the chemical structure of the product may be generated based on the product information input by a tenant, such as by determining the individual chemicals of the product and enriching the properties of each chemical in the product. In some embodiments, such as when a composite material identifier and concentration is input into the algorithm, the method includes extrapolating the two or more individual chemicals within the composite material and identifies the one or more chemical identifiers and concentrations. For example, a user may input the composite material hypochlorite and a concentration of 6% in water. In such an example, the algorithm may determine the individual chemicals of chlorine and oxygen and determine the concentration of each of these individual chemicals in the composite material.

In some embodiments, the algorithm may also identify a chemical reaction or phase change of components. For example, if sodium and water were the individual chemicals, the algorithm may determine a phase change (i.e., the solid sodium and the liquid water in combination create hydrogen gas) of the composite material.

In some embodiments, the system is configured to (1) determine the individual chemicals of a composite material (i.e., identifying oxygen and chlorine in hydrochloric acid), and/or (2) determine a composite material based on inputs of individual chemicals and concentrations (i.e., if oxygen and chlorine were input, determining the combination would be hydrochloric acid). As another example, if toluene diisocyanate (TDI) and polypropylene glycol were the individual chemicals, the algorithm may determine a chemical reaction (i.e., the reactive isocyanate groups of TDI and the hydroxyl groups of polypropylene glycol in combination create polyurethane polymer) of the composite material. In another example, if benzene and chloroform were the individual chemicals, the algorithm may determine a chemical reaction (i.e., the aromatic ring of benzene and the chloroform in the presence of a Lewis acid catalyst like aluminum chloride undergo a Friedel-Crafts alkylation to form benzyl chloride) of the composite material.

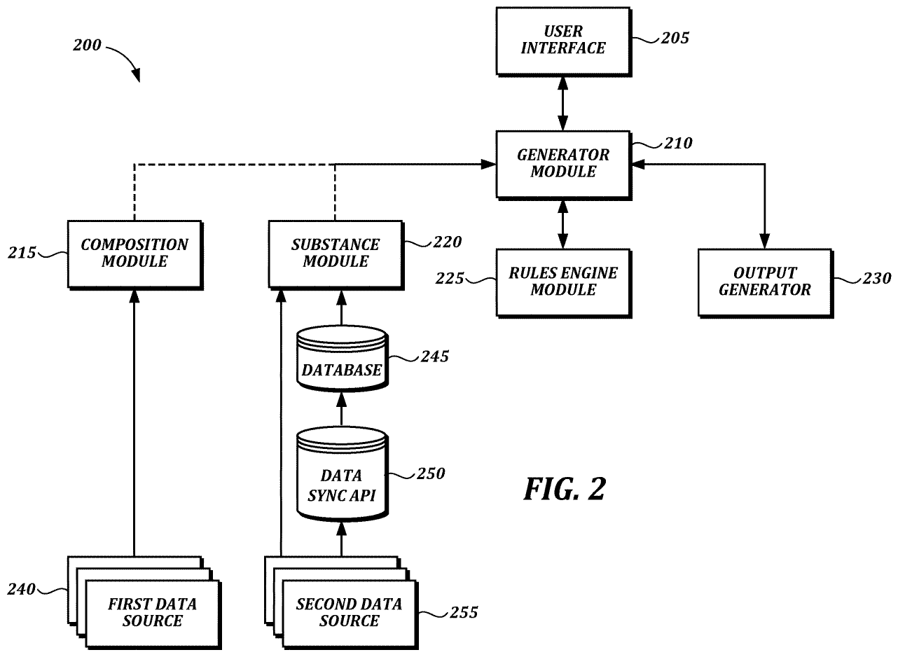

In some embodiments, the algorithm further identifies interactions between the one or more chemicals to inform the representative properties presented in the regulatory output. In some embodiments, the product information is obtained by accessing at least one data source, as described in detail in FIGS. 2A-2B.

In some embodiments, jurisdictional information 110 includes a specified regulatory authority. In some embodiments, the regulatory authority may be a general region (e.g., the United States of America) or a specific standard or regulatory agency (e.g., the Occupational Safety and Health Administration (OSHA), Department of Transportation (DOT), etc.). In some embodiments, the regulatory authority is following the Globally Harmonized System (GHS) or a specific revision of GHS. In some embodiments, the regulatory authority defines predetermined steps of an algorithm. In some embodiment the authority might be a newly formed government entity overseeing sustainability or controlling environmental impact of chemicals. In such embodiments, the predetermined steps of the algorithm include applying one or more rules of the regulatory authority to the regulatory output. In some embodiments, the regulatory authority may be a trade association, (such as Nike RSL), an industrial group, or an individual company, where such regulatory authorities may have additional or more strict rules than those of, for example, state authorities. In some embodiments, the rules of the regulatory authority include, but are not limited to, a language of the regulatory output (i.e., Spanish, English, Simplified or Traditional Chinese, and the like), a format of the regulatory output (i.e., a highlighted or bolded section), prescribed sections of the output such as headers or sub-headers, an order (i.e., composition information provided before hazard information, and vice versa), a warning (i.e., such as a requirement to use gloves when handling), a classification (i.e., radioactive, cancer-causing, and the like), or a combination thereof.

In some embodiments, the regulatory output 100 includes language information 115. In some embodiments, the language information 115 aligns with the regulatory authority in the jurisdiction information 110, but in other embodiments, the language information 115 may differ from that of the jurisdictional information 110. For example, the regulatory authority may be OSHA which would generally require the regulatory output 100 to be in English, but the regulatory output 100 may be in another language, such as Spanish. In some embodiments, the output may contain multiple languages within a single output. In some embodiments, multiple outputs may be created, each with the same or different languages, regulatory authority, etc. In some embodiments, the language information 110 is included in a header or footer of the regulatory output 100. In some embodiments, the language information 110 is not included/displayed on the regulatory output 100 but is merely applied to the regulatory output 100. In some embodiments, the language information 110 is included on a cover sheet of the regulatory output 100.

In some embodiments, the regulatory output 100 includes tenant and/or creator information 120. As explained herein, a tenant is an organization that dictates rules of the regulatory output 100, such as a lab, a firm, a school, or a business. In some embodiments, a user (also referred to as a creator) generates the regulatory output 100. The user (or creator) may be a member of the tenant. In the case that the tenant includes only a single user, the user and the tenant are the same. In some embodiments, the tenant information 120 includes the name of the tenant (such as an organization) or the name of the creator (such as an employee/member of the organization). In some embodiments, the tenant defines the predetermined steps of the algorithm. In some embodiments, there are multiple organizations or legal entities within a tenant, which can be selected prior to creating the regulatory output. In some embodiments, the predetermined steps of the algorithm include applying one or more rules of the tenant to the regulatory output 100. In some embodiments, the one or more rules of the tenant include a language of the regulatory output, a format of the regulatory output, an order of the regulatory output, a classification of one or more chemicals, or combination thereof. In some embodiments, the rules of the tenant and the rules of the regulatory authority may contradict one another. In one embodiment, there is a hierarchy between the rules of the regulatory authority and the rules of the tenant. In some embodiments, the rules of the tenant are first in the hierarchy and are thus applied as opposed to the rules of the regulatory authority when the rules of the tenant and the rules of the regulatory authority contradict, and vice versa. In some embodiments, the tenant has a specific set of rules, or access to specific data that informs the regulatory output. In some embodiments, the tenant information 120 is included in a header or footer of the regulatory output 100. In some embodiments, the tenant information 120 is not included/displayed on the regulatory output 100. In some embodiments, the tenant information 120 is included on a cover sheet of the regulatory output 100, or in the title of the regulatory output 100.

In some embodiments, the data supplied by the tenant and the data from the regulatory authority may contradict one another. In one embodiment, there is a hierarchy between the data of the regulatory authority and the data of the tenant. In some embodiments, the data of the tenant is first in the hierarchy and are thus used as opposed to the data of the regulatory authority when the data of the tenant and the data of the regulatory authority contradict, and vice versa.

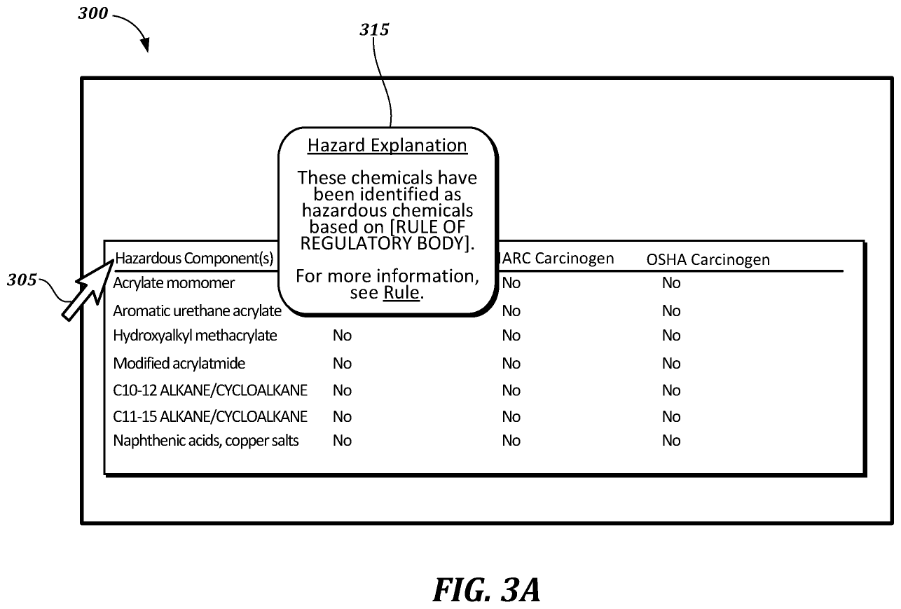

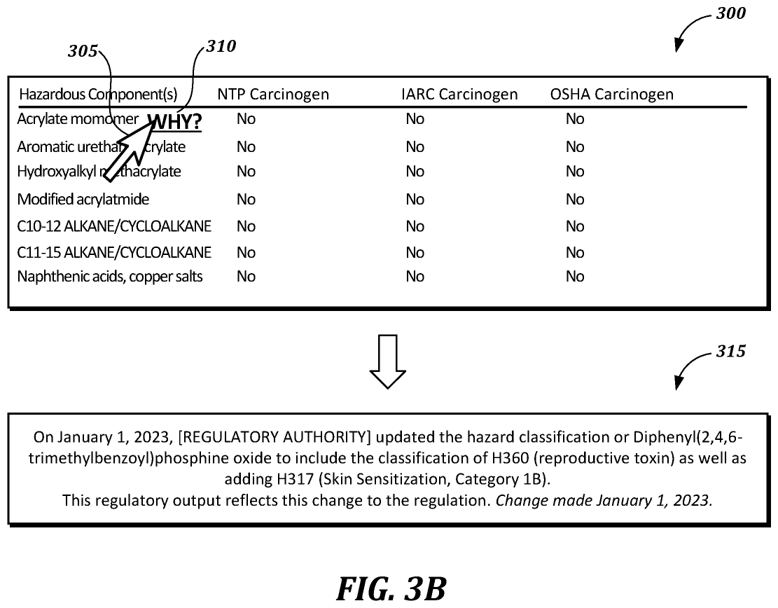

In some embodiments, the regulatory output 100 further includes a tag 130. In some embodiments, the tag is a barcode, QR code, RFID tag, web URL, or a combination thereof, or any type of machine-readable format similar. Additionally, such as when the regulatory output 100 is digital, the tag is a barcode, QR code, button, web URL or clickable link. In operation, accessing (or clicking) the tag 130 allows a user to view the regulatory output 100 digitally, translate the regulatory output 100 from one language to another, change the regulatory authority, change the tenant, edit fields (such as composition information, transportation information, etc.) of the regulatory output 100, generate a different regulatory output 100, and the like. As used herein, the term “access” includes scanning, clicking, entering into a browser, reading with RFID reader, and the like. For example, a user may access a tag 130 on a physical SDS to retrieve a digital, editable version of the SDS. The user may then change the language of the SDS, apply one or more rules of a tenant, edit fields of the SDS (such as the name of the composition or transportation information), and generate, for example, a different form of regulatory output (such as a shipping label) with the information on the SDS. Accordingly, the tag 130 allows a user to personalize the regulatory output 100 to suit specific needs and requirements. Accordingly, the tag 130 allows a user to personalize the regulatory output 100 to suit specific needs and requirements. In some embodiments, the tag 130 further allows a user to create an updated output including one or more of the following: updated rules from the regulatory authority, updated data from the chemical(s), updated template or any other updates that may have been made after the regulatory output was generated. Additionally, this output may provide explanations regarding the updates or the fields in the regulatory output (as shown and described in detail in FIGS. 3A-3B). In some embodiments, this is an editable output by the user and in other embodiments this is a read-only output. In some embodiments a change log or change report is viewable to explain the differences between the original output and the updated output. In some embodiments, a new unique ID or version ID is given to each output.

In some embodiments, the regulatory output 100 further includes hazard information 165. In some embodiments, the hazard information is informed by the regulatory authority, the tenant, the supplier, or all. For example, one regulatory authority may have a different threshold as to what qualifies as a hazard than another regulatory authority. For example, the eye corrosive hazard, H318 (Causes Serious Eye Damage) may have a 3% threshold in the USA jurisdiction while having a 1% threshold under the European Union/Registration, Evaluation, Authorization and Restriction of Chemicals (REACH) regulations. Accordingly, some chemicals or composite materials may have different hazard information 130 depending on the rules of the regulatory authority informing the regulatory output 100. For example, acrylic acid, CAS number 79-10-7, might be Acute Toxicity Oral—Category 3 under OSHA in the USA, while it may be Acute Toxicity Dermal—Category 2 under REACH. In some embodiments, the hazard information is generated by aggregating properties of one or more chemicals and enriching the properties by analyzing the interactions between the properties. These interactions can then be used to inform representative properties of one or more individual chemicals or composite material as a whole. For example, two chemicals may not cause skin irritation on their own but will cause skin irritation when combined. In such a case, the regulatory output includes hazard information 130 identifying the composite material as the one causing skin irritation. While some rules may be additive in their classification threshold, other chemicals may not be additive and should be evaluated individually. In some embodiments, the regulatory output 100 further includes an explanation of the hazard information 130, as shown and explained in FIGS. 3A-3B.

The regulatory output may include any number of fields 170A, 170B, including but not limited to a product description 105, jurisdiction information 110, language information 115, tenant and/or creator information 120, regulatory information 125, and a tag 130. It should be understood that the regulatory output 100 may omit any of these fields and may also include additional fields not illustrated in FIG. 1B, including but not limited to transportation information, toxicity information, hazard information, composition information, physical and chemical property information, stability, and reactivity information, and the like. In some embodiments, each field 170A, 170B includes one or more of the following: product description 105, jurisdiction information 110, language information 115, tenant information 120, or regulatory information 125. In some embodiments, fields 170A, 170B may include duplicate information, such as regulatory information 125. Although two fields 170A, 170B are illustrated it should be understood that any number of fields may be included, in any order.

FIG. 1B is an example portion of the regulatory output 100 of FIG. 1A, in accordance with the present technology.

In some embodiments, the regulatory output 100 includes regulation information 125. In some embodiments, the regulatory information 125 may be included in a field 170. In such embodiments, the regulatory information 125 includes regulations from the regulatory authority (or jurisdiction 110) that apply to the regulatory output. In some embodiments, the regulatory information 125 merely provides regulations from the regulatory authority that may or may not be relevant to the regulatory output. In some embodiments, regulations are considered rules of the regulatory authority. For example, as shown in FIG. 1A, one rule of the United States as a regulatory authority is that all components of a composite material must be listed unless specifically exempt under the Toxic Substances Control Act. In such an example, if the United States was selected as the regulatory authority, the algorithm would display all components or a summary of the composite which are active, inactive or not listed unless specifically exempt. Further, in such an example, the Toxic Substances Control Act would appear in the regulatory information 125.

FIG. 1C is another example portion of the example regulatory output 100 of FIG. 1A, in accordance with the present technology. In some embodiments, the regulatory output 100 includes composition information 132. In some embodiments, the composition information 132 is contained in a field 170. In some embodiments, the composition information 132 includes one or more individual chemicals 135A, 135B, 135C . . . 135N, identifiers 140A, 140B, 140C . . . 140N, and amounts 145A, 145B, 145C . . . 145 N (such as concentrations or concentration ranges, percentages, and the like). In some embodiments, the individual chemicals 135, identifiers 140, amounts 145, or a combination thereof are input into the algorithm by a user. In some embodiments, the chemicals 135, identifiers 140, amounts 145, or a combination thereof are obtained from at least one data source. In some embodiments, the chemicals 135, identifiers 140, amounts 145, or a combination thereof are obtained from at least one data source based on the identity of the composite material. In some embodiments, the identifiers are chemical abstract service (CAS) identifiers, International Union of Pure and Applied Chemistry (IUPAC) nomenclature, Simplified Molecular-Input Line-Entry System (SMILES) strings, or the like. In some embodiments, the identifiers might be cloaked or show as a generic name such as solvent or proprietary.

FIG. 1D is another example portion of the example regulatory output 100 of FIG. 1A, in accordance with the present technology. In some embodiments, the regulatory output 100 includes physical and chemical property information 150, stability and reactivity information 155, and toxicological information 160. In some embodiments, the physical and chemical property information 150, the stability and reactivity information 155, and the toxicological information 160 may each be contained in their own fields 170A, 170B, 170C respectively. Further, the physical and chemical property information 150, the stability and reactivity information 155, and the toxicological information 160 could be displayed or presented in any order. It should be understood that in some embodiments, combinations of the physical and chemical property information 150, the stability and reactivity information 155, and the toxicological information 160 could be contained in a single field. In some embodiments, the tenant, regulatory authority, or a combination thereof informs a content of, a number of and/or an order of the fields 170A, 170B, 170C. In some embodiments, the physical and chemical property information 150, stability and reactivity information 155, and toxicological information 160 are informed by the tenant, the regulatory authority, or a combination thereof. In some embodiments, the physical and chemical property information 150, stability and reactivity information 155, and toxicological information 160 are obtained by evaluating enriched properties of one or more chemicals. For example, a property of two chemicals may include a boiling point property. In such an example, the boiling point property can be obtained and enriched by accessing one or more data sources including at least the boiling point of each of the two chemicals and an explanation of cause of the boiling point of each of the two chemicals. In some embodiments, the interaction between the boiling point properties of both chemicals may then be analyzed to define a boiling point property (i.e., a representative property) of the composite material (i.e., the two chemicals combined). In such a case, the regulatory output 100 may include a boiling point of the composite material, and an explanation of the boiling point based on the two chemicals.

This may be achieved in many different ways. In some embodiments, a Raoult's Law-based model is used. In such embodiments, these models are used primarily for ideal mixtures. Raoult's Law states that the vapor pressure of each component in an ideal mixture is proportional to the vapor pressure of the pure components and their mole fraction in the mixture. The total vapor pressure is the sum of the vapor pressures of all components, and the boiling point is determined when this total vapor pressure equals the external pressure. In some embodiments, a modified Raoult's Law (or Activity Coefficient) model is used. For non-ideal mixtures, modifications of Raoult's Law are used, which incorporate activity coefficients. Models like Wilson, Non-Random Two Liquid model (NRTL), and Universal Quasichemical model (UNIQUAC) provide ways to calculate these coefficients based on the interactions between different molecules.

In some embodiments, Equation of State (EOS) Models may be used. EOS models, such Peng-Robinson and Soave-Redlich-Kwong can be used to estimate the phase behavior of mixtures, including their boiling points. These models consider the size and the interaction of molecules and are particularly useful for high pressure and temperature conditions.

In some embodiments, azeotropic data may be used. For mixtures that form azeotropes (a mixture of two or more liquids that distills at a constant temperature and composition), specific data and models are required to predict the boiling points, as the presence of an azeotrope signifies deviations from ideal behavior.

In some embodiments, empirical and semi-empirical models may be used. These models use experimental data to derive correlations that can predict boiling points. They may not provide the fundamental insight into the molecular interactions but can be quite effective for systems similar to those for which the model parameters were derived.

In some embodiments, group contribution methods may be used. In some embodiments, methods like UNIQUAC Functional-group Activity Coefficients (UNIFAC) use functional groups of the molecules in the mixture to estimate the activity coefficients, which can then be used to calculate boiling points.

In some embodiments, Machine Learning (ML) algorithms may be used. With the advent of data science in chemical engineering, machine learning models are being trained to predict properties like boiling points based on large datasets of known chemical systems. These can include regression models, neural networks, or support vector machines.

FIG. 2 is an example software architecture 200 for carrying out the methods disclosed herein, in accordance with the present technology. In some embodiments, the software architecture includes a user interface 205, a generator module 210, a composition module 215, a substance module 220, a rules engine module 225, an output generator module 230, a database 245, a data sync module 250, a first data source 240, and a second data source 255. As defined herein, a module may be a logical interface, application programming interface (API), database, sub-routine, file transfer protocol (FTP) file transfer, component, or the like.

In some embodiments, the user interface 205 is configured to receive input from a user or a tenant. In some embodiments, the user interface 205 is further configured to display the regulatory output. In operation, the user interface 205 receives input, such as an identifier or concentration of one or more chemicals, and requests the generator module 210 to generate a regulatory output. In some embodiments, the user interface 205 is further configured to receive a regulatory authority, a tenant, or a combination thereof as input. In some embodiments, the user interface 205 is not required and all operations are performed directly via module. In some embodiments, module 210 is not required.

In some embodiments, the generator module 210 receives one or more identifiers and/or concentrations from the user interface 205. In some embodiments, one or more identifiers are standard identifiers (such as a Chemical Abstract Services Identifier (CAS IDs)). In some embodiments, one or more identifiers are non-standard identifiers (such as the name of the one or more chemicals, an identifier unique to an entity, or a trade name). When the identifiers are non-standard identifiers (also called external IDs), required information, such as the standard identifier, one or more properties of one or more chemicals, or both, are fetched by the first data source 240. In some embodiments, the non-standard identifier is an internal identified from another system such as an ERP system (SAP, Oracle, or the like). In some embodiments, the generator module 210 will also be passed at least one of the following: language, product level details such as flash point, state of matter, or the like.

In some embodiments, the composition module 215 receives the list of one or more non-standard identifiers. In some embodiments, one or more non-standard identifiers is a name of a composition, that is, of a material made up of two or more chemicals. In such embodiments, the composition module 215 uses the first data source 240 to break down the composition into individual chemicals having a target quantity (or concentration) and an identifier. The composition module 215 may then send the target quantity and identifiers of each individual chemical in the composition back to the generator module 210. In some embodiments, such as when a single individual chemical is input into the generator module 210, this step may be omitted. In some embodiments, a regulatory authority is also input into the user interface 205. In such embodiments, the composition module 215 also passes the regulatory authority to the first data source 240, which defines the individual chemical identifier returned to the generator module by the first data source 240. In some embodiments, the composition module 215 may be omitted.

In some embodiments, the substance module 220 receives the identifiers and returns substance specific information required for the rule engine module 225 to make decisions on the regulatory output. In some embodiments, the substance module 220 receives both the identifiers (standard or non-standard) and a specified regulatory authority as described herein. In some embodiments, the identifiers are received in a comma separated list or JSON format. In some embodiments, the substance module 220 receives information from a database 245, a data sync module 250, and a second data source 255.

In some embodiments, the first data source 240 is configured to track and store information about identifiers of one or more chemicals. In some embodiments, the first data source 240 is further configured to take an input of a composition and break down the composition into individual chemicals. In such embodiments where a single individual chemical is input into the system, the first data source 240 may not necessarily be utilized. In some embodiments, the first data source 240 is a primary reference, that is, test results or information that is generated by testing. In some embodiments, the first data source 240 is a secondary reference, such as a database of collected testing data. In some embodiments, the first data source 240 is an internal data source that is generated and/or maintained by the tenant or user. In some embodiments, the first data source 240 is an external data source provided by a third party. In some embodiments, the first data source 240 includes a predicted or simulated property, such as the result from a machine learning algorithm or quantitative structure activity relationship (QSAR) model. In this manner, the first data source 240 may be a data generator.

In some embodiments, the software further includes a rules engine module 225. In some embodiments, the rules engine module 225 compiles and applies one or more rules to generate the regulatory output. In some embodiments, the one or more rules are based on the specified regulatory authority, the tenant, or a combination thereof. In some embodiments, the rules engine module 225 generates one or more fields of the regulatory output. In some embodiments, the one or more fields may include hazard statements, prevention statements, pictograms, signal word, composition information, first aid measures, firefighting measures, accidental release measures, handling and storage details, exposure controls and personal protection, regulatory information, transporting guidelines, disclosure guidelines, for the makeup of the one or more chemicals, and text generation. For example, in some embodiments, the rules engine module 225 receives a hazard value for a chemical from the composition module 215, the substance module 220, or both. In some embodiments, the rules engine module 225 determines if that hazard value exceeds a hazard threshold to determine whether the chemical or product is considered a hazard. The rules engine module 225 then passes this information back to the generator module 210. The generator module 210 then passes this information to the output generator module 230 so that this information appears in a field in the regulatory output. Accordingly, in operation, the rules engine module 225 applies the rules of the tenant, regulatory authority, or both that define one or more fields in the regulatory output. In some embodiments, rules may trigger other rules in a cascading manner.

In some embodiments, the software 200 may further include a data sync module 250. In some embodiments, the data sync module 250 is configured to receive one or more tables of the second data source 255 in sync with data in the database 245. In some embodiments, the data sync module 250 is a nodejs script. In some embodiments, the second data source 255 may include data from a third-party provider such as the European Chemicals Agency (ECHA). In some embodiments, the second data source 255 may provide data directly to the substance module 220, i.e., without transmitting data to data sync module 250 and/or the database 245.

In some embodiments, the second data source 255 includes a predicted or simulated property, such as the result from a machine learning algorithm or quantitative structure activity relationship (QSAR) model. In this manner, the second data source 255 may also be a data generator.

Finally, in some embodiments, the software 200 may include an output generator module 230. The output generator module 230 may generate any number of formats for the regulatory output. In some embodiments, for example, the output generator module 230 generates a certificate, a printable document, or the like. The output generator module receives data from the generator module 225 including, but not limited to, one or more chemical identifiers, a regulatory authority, one or more representative properties of the individual chemicals, one or more output templates, and one or more fields based on the one or more rules from the rule engine module 225. In some embodiments, the output generator module 230 takes this data and generates a regulatory output. In some embodiments, the output generator module 230 the returns the regulatory output to the generator module 210. In some embodiments, the one or more output templates include an order of fields, a style, a font, and the like.

In some embodiments, in operation, one or more names or identifiers of chemicals are input into the software 200. When the one or more chemicals are in a composition having a non-standard identifier, the generator module 210 passes this data to the composition module 215, which accesses the first data source 240 to determine the individual chemicals and their standard identifiers. In embodiments where only a chemical is input into the generator module 210, this step may be omitted. In operation, the substance module 220 takes either the individual chemicals and standard identifiers from the composition module 215 or from the generator module 210 and passes this information, in combination with a regulatory authority, and generates representative properties for the one or more chemicals. In some embodiments, this information is passed back to the generator module 210. Then, the generator module passes this information to the rules engine module 225, which applies rules based on a selected tenant, regulatory authority, or both to generate fields of a future regulatory output. The rules engine module 225 then passes these generated fields back to the generator module 210. The generator module passes all data accumulated by each of the modules 215, 220, 225 to the output generator module 230. The output generator module then generates the regulatory output and passes the regulatory output to the generator module 210. Finally, the generator module 210 sends the regulatory output to the user interface 205 which displays the generated regulatory output.

FIG. 3A is a regulatory output 300 with an example explanation 315, in accordance with the present technology. It should be understood that regulatory output 300 may be any regulatory output, including regulatory output 100. In some embodiments, the regulatory output is a PDF, a static or editable webpage, or another digital format. In such embodiments, a pointer 305, such as a mouse pointer may be utilized by a user to interact with the regulatory output 300. In some embodiments, a mobile device, tablet, AR or VR wearable device is used to interact with the regulatory output 300.

In some embodiments, the regulatory output 300 may include an explanation 315. In some embodiments, the explanation 315 may be a pop-up window containing the explanation 315. In operation, a user may move a pointer 305 over a field to view explanation 315. For example, as illustrated in FIG. 3A, the field is titled “Hazardous Component(s)”. By hovering over the field with the pointer 305, an explanation 315 of the field appears. As shown in the explanation 315, the explanation 315 may include the rule that informed this field, or access to one or more rule that informed the field. In some embodiments, the explanation 315 may be displayed at all times on the regulatory output 300 (such as shown by the regulatory information 125 of FIG. 1A). In some embodiments, there may be an explanation 315 for each field of the regulatory output 300. In some embodiments, there is an explanation 315 for any number of fields of the regulatory output 300.

FIG. 3B is a regulatory output 300 with another example explanation 315, in accordance with the present technology. In some embodiments, the explanation 315 includes a clickable link 310 configured to display explanation 315. In operation, a user may click the link 310 with a pointer 305, such as a mouse pointer. In some embodiments, the user is directed towards a separate page including the explanation 315. In some embodiments, the explanation 315 is an explanation of one or more updates to the regulatory output 300. In some embodiments, the explanation 315 includes the date the one or more rule changed, where the one or more rule originated from (such as from a tenant or a regulatory authority), and when the update to the regulatory output 300 occurred. In some embodiments the explanation also include the source of the data and sometimes the specific data source if there are more than one data sources. In some embodiments, generative Artificial Intelligence (AI) or Large Language Models (LLMs) are used to explain the regulatory output to the user.

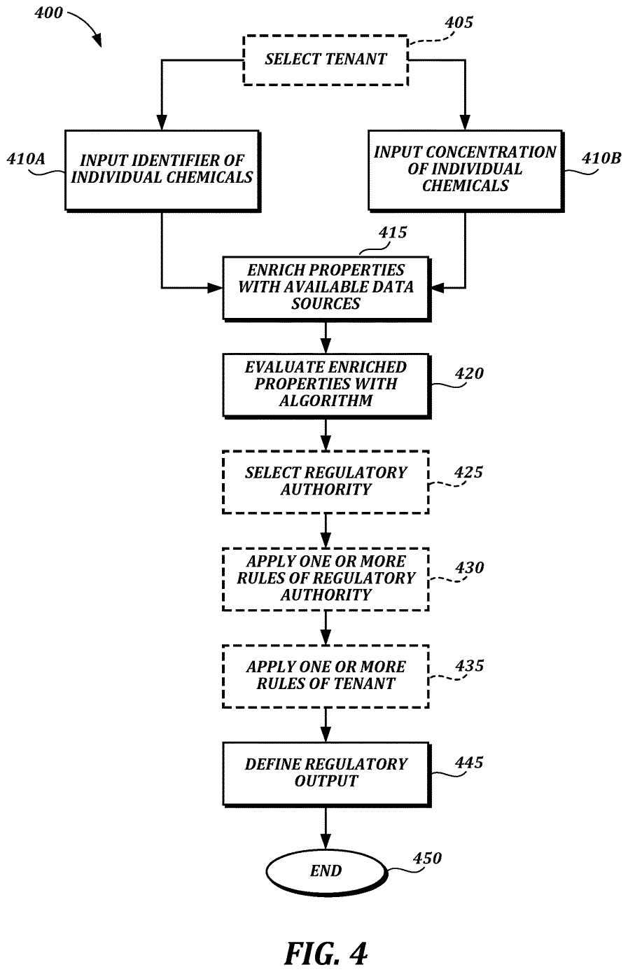

FIG. 4 is an example method 400 of generating a regulatory output, in accordance with the present technology. It should be understood that the regulatory output may be any of the regulatory outputs 100, 300 as described herein, and may be generated by the software architecture 200. In some embodiments, the method begins in block 405. Optionally in block 405, a tenant is selected. In some embodiments, a step of selecting a tenant is skipped, and the method begins from blocks 410A and 410B. In some embodiments, the tenant defines one or more rules that may be incorporated into the regulatory output.

In blocks 410A and 410B, one or more identifiers of one or more individual chemicals and one or more concentrations of the one or more individual chemicals are input into the system, respectively. In some embodiments, only the one or more identifiers or the one or more concentrations are input. In some embodiments, the one or more individual chemicals may be input as one or more composite materials including of one or more induvial chemicals. In such embodiments, the one or more concentrations may be the concentration of only the composition, as opposed to the concentration(s) of the one or more individual chemicals.

In block 415, properties of the one or more individual chemicals are enriched. In some embodiments, enrichment of the properties includes accessing one or more data source to accumulate the enriched properties, as described herein. In some embodiments, this step is carried out by the substance module (such as substance module 220 as shown in FIG. 2).

In block 420, the enriched properties are evaluated with an algorithm. In some embodiments, the algorithm is carried out by the rules engine module (such as rule engine module 225 of FIG. 2). In some embodiments, enriching the properties includes considering interactions between the one or more individual chemicals.

Optionally, in block 425 a regulatory authority is selected. In some embodiments, the regulatory authority may be a general region (such as the United States or North America) or a specific regulatory agency (such as OSHA or GHS). In some embodiments, the regulatory authority defines one or more rules that will be applied to the regulatory output.

Optionally, in block 430, the rules of the one or more regulatory authority are applied. As described herein, the one or more rules of the regulatory authority may include a language, a format, an order, a template, a classification, or a combination thereof. For example, the one or more rules of the regulatory authority may include a classification that the one or more individual chemicals are hazardous, toxic, or regulated based on the specific regulatory authority. As another example, the one or more rules of the regulatory authority may require a field regarding safe transportation of the one or more chemicals before a field regarding the chemical composition of the one or more chemicals.

Optionally, in block 435, one or more rules of the tenant is applied to the regulatory output. In some embodiments, the one or more rules of the tenant may include a language, a format, an order, a classification, or a combination thereof. For example, the rules of the tenant may require a document to be in a specific language. Further, for example, the rules of the tenant may have a threshold for determining when one or more individual chemicals are considered hazardous. Further, there may be different specified product types, which are predefined output fields to be included in the output document. These product types may be used to define certain “soft sections” or parts of the regulatory output which are not driven by rules or an algorithm. In some embodiments, these soft sections could be determined by the algorithm itself. In some embodiments, there may be additional tenant specific fields included in the output, such as color, odor, etc.

Finally, in block 445, the regulatory output is defined. In some embodiments, the regulatory output is determined based on the enriched properties, the one or more rules of the tenant, the one or more rules of the regulatory authority, or a combination thereof. In some embodiments, the regulatory output is a safety data sheet (SDS), a label, a sticker, a dossier, a notification, a digital submission, a registration, a certificate, a webpage, or a combination thereof.

The method may end in block 450.

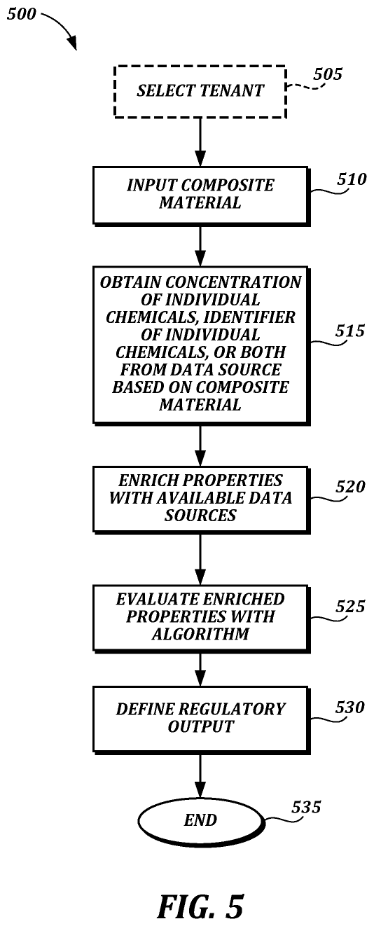

FIG. 5 is another example method 500 of generating a regulatory output, in accordance with the present technology. In block 505, optionally, a tenant is selected. As explained herein, the tenant may inform the regulatory output based on one or more rules of the tenant.

In block 510, a composite material is input. In some embodiments, the composite material is made up of two or more individual chemicals. In some embodiments, the two or more individual chemicals are unknown to a user of the method.

In block 515, concentrations of the individual chemicals, identifiers of individual chemicals, or both of the individual chemicals of the composite material are obtained. In some embodiments, this step is carried out by the composition module as illustrated in FIG. 2. The expression module refers to any algorithm that is executed by a computer, whether such an algorithm requires an input from a user of not, or whether input/output of the algorithm is displayed to the user. In some embodiments, after the identifiers are obtained, properties of the two or more individual chemicals are obtained from one or more data sources.

In block 520, properties of the two or more individual chemicals are enriched. In some embodiments, enrichment of the properties includes accessing one or more data sources to accumulate the enriched properties. In some embodiments, this step is carried out with the substance module as shown in FIG. 2.

In block 525, the enriched properties are evaluated with an algorithm. In some embodiments, the algorithm is carried out with the rules engine (embodied in a module or otherwise) of FIG. 2. In some embodiments, enriching the properties includes considering interactions between the one or more individual chemicals. In some embodiments, properties may not be available for one or more individual chemicals, in which case the properties may be predicted or calculated based on a algorithm, including by not limited to a regression, classification, machine learning or QSAR model.

Finally, in block 530, the regulatory output is defined. In some embodiments, the regulatory output is determined based on the enriched properties, the one or more rules of the tenant, the one or more rules of the regulatory authority, or a combination thereof. In some embodiments, the regulatory output is a safety data sheet (SDS), a label, a sticker, a dossier, a notification, a digital submission, a registration, a certificate, a webpage, or a combination thereof.

In block 535, the method ends.

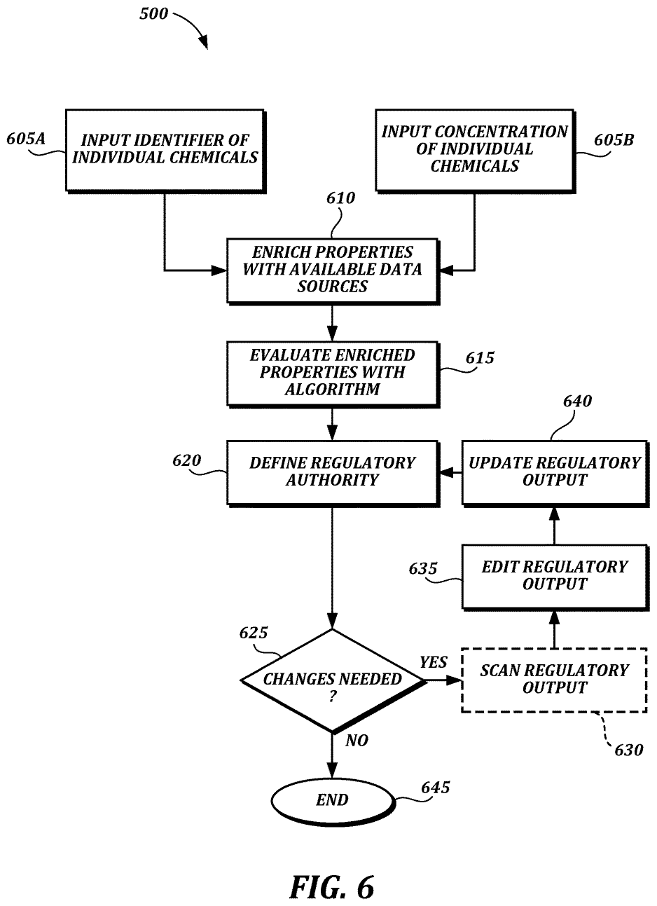

FIG. 6 is an example method 600 of generating and updating a regulatory output, in accordance with the present technology.

In blocks 605A and 605B, one or more identifiers of one or more individual chemicals and one or more concentrations of one or more individual chemicals are input into the system, respectively. In some embodiments, only one or more identifiers or one or more concentrations are input. In some embodiments, one or more chemicals may be input as one or more composite materials made up of one or more individual chemicals. In such embodiments, one or more concentrations may be the concentration of only the composite material, as opposed to the concentration(s) of one or more individual chemicals.

As used herein, an “input” is any data selected by a tenant and/or user of the method. Example inputs include the one or more individual chemicals, an identity of a composite material, an amount of a composite material, a concentration of one or more individual chemicals, a tenant input, a regulatory input as explained herein, properties of one or more individual chemicals, and the like.

In block 610, properties of one or more individual chemicals are enriched. In some embodiments, enrichment of the properties includes accessing one or more data sources to accumulate the enriched properties. In some embodiments, this step is carried out with the substance module as shown in FIG. 2.

In block 615, the enriched properties are evaluated with an algorithm. In some embodiments, the algorithm is carried out with the rules engine module of FIG. 2. In some embodiments, enriching the properties includes considering interactions between the one or more individual chemicals. For example, if the individual chemicals input represent the constituent chemicals of an epoxy resin, enriching the properties may include determining a chemical identifier of the combination of the one or more individual chemicals (such as an International Union of Pure and Applied Chemistry (IUPAC) name, like prop-2-enoic acid in the case of epoxy resin), determining a chemical structure of the one or more individual chemicals, any hazards of the one or more individual chemicals (such as skin irritation in the case of epoxy resin), and the like. In such embodiments, enriched properties include chemical properties, hazards, storage requirements, reporting requirements, and the like.

In block 620, the regulatory output is defined. In some embodiments, the regulatory output is determined based on the enriched properties, the one or more rules of the tenant, the one or more rules of the regulatory authority, or a combination thereof. In some embodiments, the regulatory output is a safety data sheet (SDS), a label, a sticker, a dossier, a notification, a digital submission, a registration, a certificate, a webpage, or a combination thereof. In some embodiments, the regulatory output is physical, but in other embodiments, the regulatory output may be digital or both.

In decision block 625, a determination is made whether the regulatory output needs to be changed. In some embodiments, the regulatory output may be changed to apply one or more updates or one or more rules of the tenant or regulatory authority. In some embodiments, the regulatory output may be changed to accommodate the needs of a user. For example, the regulatory output may be in a language that a user cannot read. In another example, new data may be available for one or more individual chemicals in which case the regulatory output may be updated or different from the original output. In some embodiments, a notification is sent to notify that a change has occurred.

If changes are needed, the method proceeds to block 630 or 635. Optionally, in block 630, the regulatory output is accessed, which may happen long after the first output is created. In some embodiments, the regulatory output is a physical regulatory output, such as a sticker, label, or paper SDS. In such embodiments, the regulatory output may include a tag (such as shown in FIG. 1A). In such embodiments, a user can access the tag of the regulatory output in order to make changes. In some embodiments, such as when the regulatory output is digital, the tag may be a link, a QR code or the like. If the regulatory output does not include a tag, the method proceeds to block 635.

In block 635, the regulatory input is edited. In some embodiments, the regulatory input is edited by a user. As used herein, a regulatory input is a selection of a regulatory authority (such as the United States, Europe, or the like). For example, a tenant and/or creator may select the United States and the state of California as the regulatory authority that governs the regulatory output. In such an example, the United States and the state of California are “regulatory inputs.” In some embodiments, the regulatory output is edited automatically, such as by updating a field on the regulatory output based on a change of a rule. In some embodiments, the edit could save an update in the data of one or more of the data sources, such as the tenant specific data. In some embodiments, updating the regulatory input is performed by the rules engine module of FIG. 2.

In block 640, the regulatory output is updated. The method then proceeds to block 620.

Returning to block 625, if no changes are needed, the method proceeds to block 645. In block 645, the method ends.

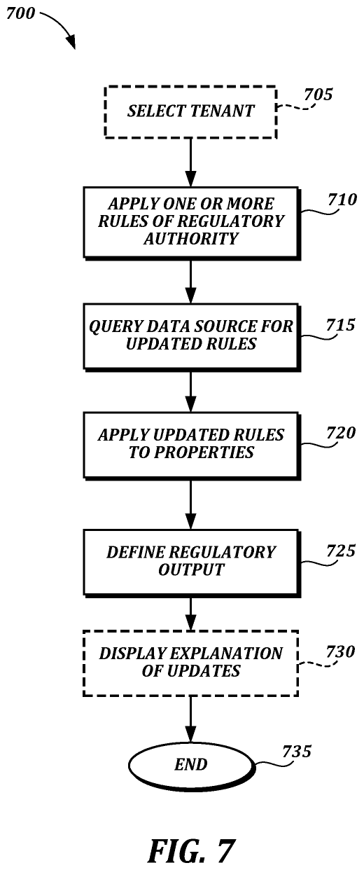

FIG. 7 is another example method 700 of generating and updating a regulatory output, in accordance with the present technology. In block 705, a regulatory authority is selected. In some embodiments, the regulatory authority applies a set of rules to the regulatory output based on one or more rules of the regulatory authority. It should be understood that the one or more rules include laws, regulations, and codes of the regulatory authority.

In block 710, the rules of the one or more regulatory authority are applied. In some embodiments, the rules may include a language, a format, an order, a classification, or a combination thereof. For example, one or more rules may include a classification that the one or more individual chemicals are hazardous, toxic, or regulated based on the specific regulatory authority. As another example, one or more rules may require a field on safe transportation before a field on composition.

In block 715, at least one data source is queried to determine if the rules of the regulatory authority have been updated since they were applied. In some embodiments, the time between blocks 710 and 715 may be hours, days, months, or years. In some embodiments, this update is done automatically, based on a time set in the system or by the tenant. In some embodiments, this update is done manually by a user.

In block 720, the updated rules are applied to properties of one or more individual chemicals input into the software. In some embodiments, this step is carried out with the rules generator module of FIG. 2.

In block 725, the regulatory output is defined. In some embodiments, the regulatory output is determined based on the enriched properties, the one or more rules of the tenant, the one or more rules of the regulatory authority, or a combination thereof. In some embodiments, the regulatory output is a safety data sheet (SDS), a label, a sticker, a dossier, a notification, a digital submission, a registration, a certificate, a webpage, or a combination thereof.

Optionally, in block 730, an explanation of the updates is defined. In some embodiments, the explanation is a pop-up window or a clickable link, such as shown in FIGS. 3A and 3B. In some embodiments, the explanation is added directly to the regulatory output. In some embodiments, the explanation could lead to another explanation such as a hazard pictogram leading to a hazard classification which in turn is leading to a individual chemical (wherein the hazard pictogram is appearing due to the hazard classification and the hazard classification is appearing due to the chemical composition). In some embodiments, the users can update the data or the rule while viewing the explanation.

In block 735, the method ends.

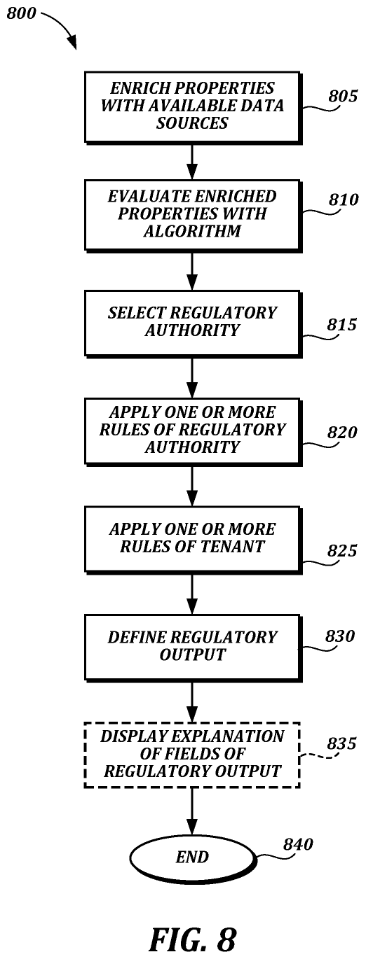

FIG. 8 is another example method 800 of generating a regulatory output, in accordance with the present technology.

In some embodiments, the method 800 includes applying rules of a regulatory authority and a tenant. It should be understood that in some embodiments, block 805 is the same as block 415, 515, or 615, as described herein. Accordingly, in some embodiments, some or all of the steps of methods 400, 500, and 600 may be included in method 800. In block 805, properties of the one or more individual chemicals are enriched. In some embodiments, enrichment of the properties includes accessing one or more data sources to accumulate the enriched properties. In some embodiments, this step is carried out with the substance module as shown in FIG. 2.

In block 810, the enriched properties are evaluated with an algorithm. In some embodiments, the algorithm is carried out with the rules engine module of FIG. 2. In some embodiments, enriching the properties includes considering interactions between the one or more individual chemicals.

In block 815, a regulatory authority is selected. In some embodiments, a choice of the regulatory authority triggers an application of one or more rules of the regulatory authority to the regulatory output.

In block 820, the rules of the one or more regulatory authority are applied. As described herein, the rules may include a language, a format, an order, a classification, or a combination thereof.

In block 825, one or more rules of the tenant is applied to the regulatory output. In some embodiments, the one or more rules of the tenant may include a language, a format, an order, a classification, or a combination thereof. For example, the rules of the tenant may require a document to be in a specific language. Further, for example, the rules of the tenant may have a threshold for determining when one or more individual chemicals are considered hazardous.

In block 830, the regulatory output is defined. In some embodiments, the regulatory output is determined based on the enriched properties, the one or more rules of the tenant, the one or more rules of the regulatory authority, or a combination thereof. In some embodiments, the regulatory output is a safety data sheet (SDS), a label, a sticker, a dossier, a notification, a digital submission, a registration, a certificate, a webpage, or a combination thereof.

In block 835, optionally, an explanation of fields of the regulatory output is displayed. In some embodiments, the explanation is a pop-up window or a clickable link, such as shown in FIGS. 3A and 3B. In some embodiments, the explanation is added directly to the regulatory output.

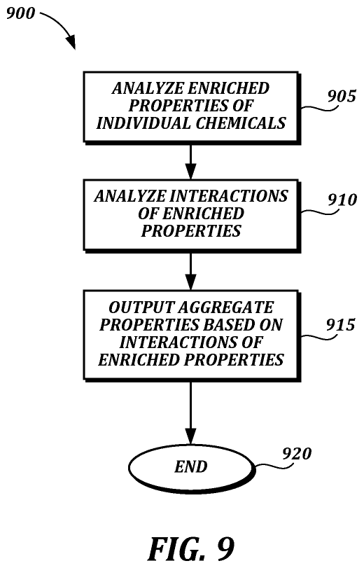

FIG. 9 is an example method 900 of analyzing interactions of properties to define a regulatory output, in accordance with the present technology.

In block 905, the enriched properties are evaluated with an algorithm. As with method 800, block 905 may be the same as blocks 415, 515, 615 or 805. In some embodiments, steps of methods 200, 300, 400, 500, 600, 700, or 800 are included in method 900. In some embodiments, the algorithm is carried out with the rules engine module of FIG. 2. In some embodiments, enriching the properties includes considering interactions between the one or more individual chemicals.

In block 910, interactions of the enriched properties are analyzed. In some embodiments, this step is also carried out by the rules engine module of FIG. 2. In some embodiments, the interactions may inform one or more fields of the regulatory output. For example, in some embodiments, the one or more individual chemicals may interact in a way that produces a toxic composition, even if neither individual chemical is toxic on its own.

In block 915, aggregate properties of one or more chemicals (or composite material) are output in the regulatory output based on the interactions of the enriched properties. In some embodiments, the regulatory output displays the aggregate properties.

In block 920, the method ends.

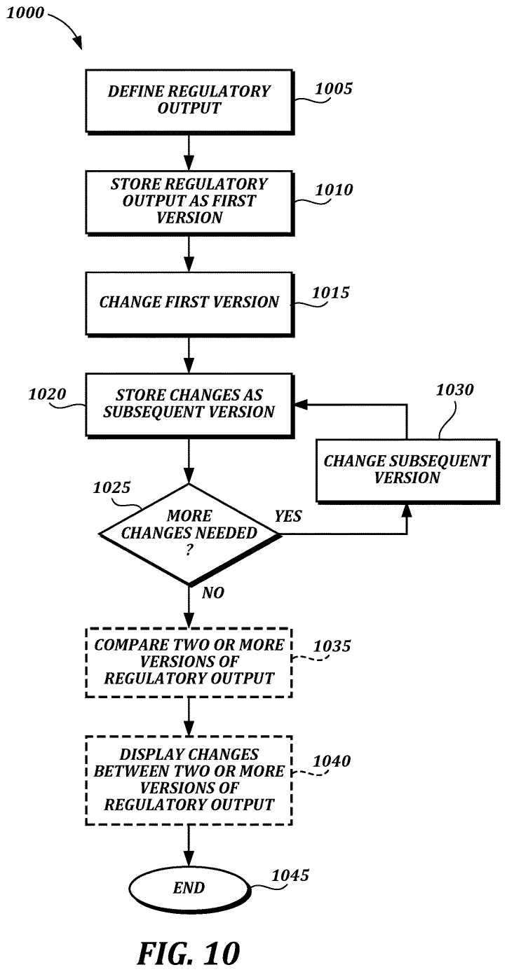

FIG. 10 is an example method 1000 of generating multiple versions of a regulatory output, in accordance with the present technology.

In block 1005, the regulatory output is defined. As mentioned above, the regulatory output may be determined based on enriched properties of one or more individual chemicals, one or more rules of the tenant, one or more rules of the regulatory authority, or a combination thereof. In some embodiments, the regulatory output is a safety data sheet (SDS), a label, a sticker, a dossier, a notification, a digital submission, a registration, a certificate, a webpage, or a combination thereof. It should be understood that method 1005 may take place after any of the preceding methods, 400, 500, 600, 700, 800, and 900. In some embodiments, it may be possible to create multiple outputs, such as outputs with different languages.

In block 1010, the regulatory output is stored as a first version of the regulatory output. In some embodiments, the first regulatory output is digitally stored. In some embodiments, a physical copy of the regulatory output is generated, while a digital copy of the regulatory output is stored as the first version of the regulatory output.

In block 1015, the first version of the regulatory output is changed. In some embodiments, the first version is changed with the method 600, where the regulatory output is edited and updated. In some embodiments, a tag of the regulatory output is accessed before making changes to the regulatory output.

In block 1020, the changes are stored as a subsequent version of the regulatory output. In some embodiments, the subsequent version of the regulatory output is a second physical regulatory output, a second digital regulatory output, or both. In some embodiments, the first version and the subsequent version are both saved, allowing a user to review both the first version and the subsequent version.

In decision block 1025, it is determined whether further versions are needed. If more changes are needed, the method proceeds to block 1035.

In block 1030, the regulatory output is changed. It should be understood that the subsequent version of the regulatory output may be changed in any of the ways as described herein, including with the method 600. In some embodiments, any number of subsequent versions may be stored. The method then returns to block 1020.

Returning to the decision block, when no further changes are needed, the method optionally proceeds to block 1035.

Optionally, in block 1035, two or more versions of the regulatory output, which may be selected from the first version and all subsequent versions, are compared. In some embodiments, comparing the two or more versions includes providing a document listing the changes between the two or more versions. In some embodiments, any version is compared to any other version of the regulatory output. In some embodiments, the regulatory output is a PDF or other digital document.

In block 1040, optionally, the changes between the two or more versions of the regulatory output are displayed. In some embodiments, displaying the regulatory outputs includes displaying the two or more versions side by side and pointing out the differences between each version of the two or more versions. In some embodiments, pointing out the differences includes bolding, highlighting, underlining, or otherwise modifying the text to show the differences of the two or more versions. In some embodiments, displaying the comparisons of the two or more versions includes displaying a preceding version of the regulatory output and displaying the changes of one or more subsequent versions as highlighted, underlined, bolded, or otherwise distinguished. In some embodiments, each subsequent version of the one or more subsequent versions is assigned a color, font, or style, so that a user can distinguish between each version changes.

In block 1045, the method ends.

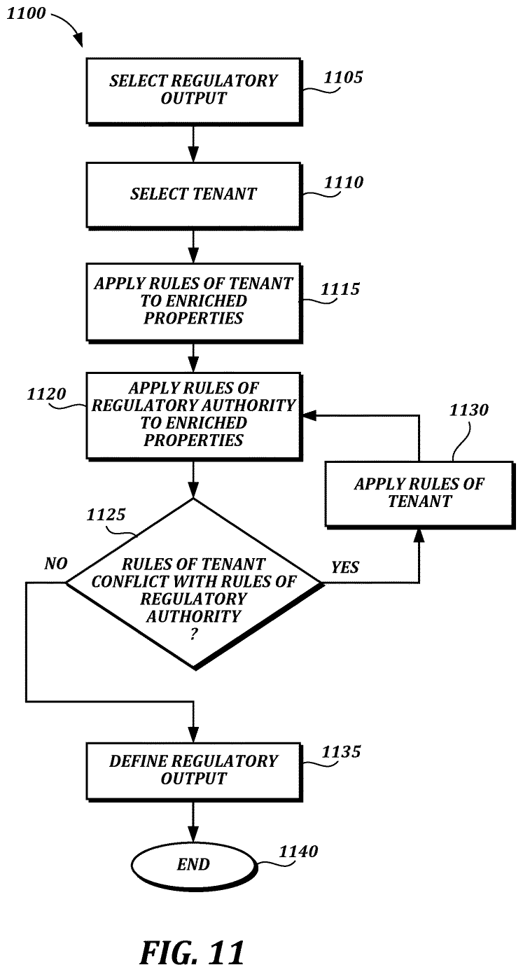

FIG. 11 is an example method 1100 of generating a regulatory output with a hierarchy of rules, in accordance with the present technology.

In block 1105, a regulatory authority is selected. In some embodiments, the regulatory authority applies a set of rules to the regulatory output based on rules, regulations, or codes of the regulatory authority.

In block 1110, a tenant is selected.

In block 1115, one or more rules of the tenant are applied to the regulatory output. In some embodiments, the one or more rules of the tenant may include a language, a format, an order, a classification, or a combination thereof. For example, the rules of the tenant may require a document to be in a specific language. Further, for example, the rules of the tenant may have a threshold for determining when one or more individual chemicals are considered hazardous.

In block 1120, the rules of the one or more regulatory authority are applied. As described herein, the rules may include a language, a format, an order, a classification, or a combination thereof. For example, the one or more rules may include a classification that the one or more individual chemicals are hazardous, toxic, or regulated based on the specific regulatory authority. As another example, the one or more rules may require a field on safe transportation before a field on composition.

In decision block 1125, if the rules of the tenant conflict with the rules of the regulatory authority, the method proceeds to block 1130.

In block 1130, the rules or data of the tenant are applied instead of the rules of the regulatory authority. For example, if the regulatory authority has a rule that the regulatory output should be in the German language, but the tenant has a rule that all regulatory outputs should be in the Chinese language, the regulatory output retains the other rules of the regulatory authority but changes the language to Chinese. For another example, the hazard classification of acetone is flammable category 3 within the data source of the regulatory authority, but the data source of the tenant has acetone with a flammable category 4 classification. In some embodiments, this can be due to different test methods for determining the data or internal tenant test data which is not publicly available. The method then proceeds to block 1135. In some embodiments, the opposite if true. For example, in some embodiments, the regulatory authority rules are applied instead of the rules of the tenant. In both cases, there is a hierarchy (or priority) between the one or more rules or data of the tenant and the one or more rules of the regulatory authority.

Returning to decision block 1125, if the rules of the tenant do not contradict the rules of the regulatory output, the method proceeds to block 1135.

In block 1135, the regulatory output is defined. In some embodiments, the regulatory output is determined based on the enriched properties, the one or more rules of the tenant, the one or more rules of the regulatory authority, or a combination thereof. In some embodiments, the regulatory output is a safety data sheet (SDS), a label, a sticker, a dossier, a notification, a digital submission, a registration, a certificate, a webpage, or a combination thereof.

In block 1140, the method ends.

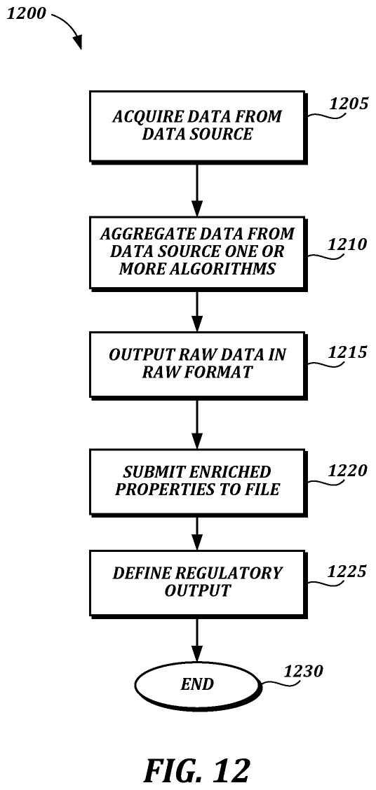

FIG. 12 is another example method 1200 of generating a regulatory output, in accordance with the present technology.

In block 1205, data regarding one or more chemicals is acquired from the at least one data source.

In block 1210, the data from the at least one data source is aggregated using one or more algorithms. In some embodiments, the one or more algorithms include a Rete algorithm, a conditional algorithm, a decision tree, one or more machine learning algorithms, one or more treat algorithms, a leaps algorithm, a Gator network, or a combination thereof to define enriched properties.

In block 1215, raw data is output in a raw format. In some embodiments, the raw format is a csv file, a txt file, a bin file, a JavaScript Object Notation (JSON) file, HTML or a combination thereof.

In block 1220, the enriched properties are submitted to a file. In some embodiments, the file is an external call, a PDF file, an image file, or a combination thereof.

In block 1225, the regulatory output is defined. In some embodiments, the regulatory output is determined based on the enriched properties, the one or more rules of the tenant, the one or more rules of the regulatory authority, or a combination thereof. In some embodiments, the regulatory output is a safety data sheet (SDS), a label, a sticker, a dossier, a notification, a digital submission, a registration, a certificate, a webpage, or a combination thereof.

In block 1230, the method ends.

It is appreciated that the order in which some of the process blocks appear in methods 400, 500, 600, 700, 800, 900, 1000, 1100, and 1200 should not be deemed limiting. Rather, one of ordinary skill in the art having the benefit of the present disclosure will understand that some of the process blocks may be executed in a variety of orders not illustrated, or even in parallel. It should be understood that all methods 400, 500, 600, 700, 800, 900, 1000, 1100, and 1200 should be interpreted as merely representative. In some embodiments, process blocks of all methods 400, 500, 600, 700, 800, 900, 1000, 1100, and 1200 may be performed simultaneously, sequentially, in a different order, or even omitted, without departing from the scope of this disclosure.

The above description of illustrated examples of the invention, including what is described in the Abstract, is not intended to be exhaustive or to limit the invention to the precise forms disclosed. While specific examples of the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific examples disclosed in the specification. Rather, the scope of the invention is to be determined entirely by the following claims, which are to be construed in accordance with established doctrines of claim interpretation.

1. A method for generating a regulatory output for chemicals, chemical compositions, materials, or articles, the method comprising:
inputting one or more identifiers of one or more individual chemicals into an algorithm;
inputting one or more concentrations of one or more individual chemicals into the algorithm;
enriching properties of the one or more individual chemicals by obtaining properties of the one or more individual chemicals from at least one data source to generate enriched properties;
evaluating the enriched properties of the one or more individual chemicals to generate representative properties of the one or more individual chemicals by applying predefined steps of the algorithm; and
generating the regulatory output of the chemical, chemical composition, material, or article based on the representative properties of the one or more individual chemicals.

2. (canceled)

3. The method of claim 1, wherein the properties of the at least one individual chemical is selected from a group consisting of a boiling point, a melting point, a toxicological value, a global regulation status, a chemical structure, one or more hazard identifications, one or more first aid measures, regulatory information, and combinations thereof.

4. The method of claim 1, wherein the one or more chemicals form a composite material, and the method further comprises:
inputting an identifier of the composite material;
inputting an amount of the composite material;
obtaining the one or more identifiers of the one or more chemicals from at least one data source based on the composite material;
obtaining the one or more concentrations of the one or more chemicals from the at least one data source based on the composite material.

5. The method of claim 4, wherein the method further comprises obtaining both the one or more identifiers and the one or more concentrations of the one or more chemicals from the data source based on the composite material.

6. The method of claim 1, wherein the method further comprises selecting a tenant before any input.

7. The method of claim 6, wherein the tenant defines the one or more identifiers, one or more concentrations, or both the one or more identifiers and the one or more concentrations of the one or more individual chemicals.

8-11. (canceled)

12. The method of claim 1, wherein the regulatory output is configured to be editable by a user, and wherein when a user makes one or more edits, the regulatory output is updated to include the one or more edits made by the user.

13-14. (canceled)

15. The method of claim 1, wherein the method further comprises selecting a specified regulatory authority, jurisdiction, or language.

16-23. (canceled)

24. The method of claim 1, wherein the method further comprises:
storing the regulatory output as a first version;
changing the first version;
storing the changes as a subsequent version; and
when additional changes are made, storing each additional set of changes as an additional version.

25. The method of claim 24, wherein the method further comprises:
selecting two or more versions of a plurality of versions, wherein the plurality of versions comprises the first version, the subsequent version, and any number of additional versions;
comparing the two or more versions of the plurality of versions to determine changes between the two or more versions; and
displaying the changes between the two or more versions.

26. The method of claim 1, wherein both a tenant and a regulatory authority inform the predetermined steps of the algorithm so that the algorithm includes both one or more rules of the tenant and one or more rules or data of the regulatory authority.

27. The method of claim 26, wherein there is a hierarchy between the one or more rules or data of the tenant and the one or more rules of the regulatory authority.

28. The method of claim 27, wherein the one or more rules or data of the tenant are first in the hierarchy.

29. The method of claim 1, the method further comprising:
accessing a tag of the regulatory output;
adjusting the one or more identifiers, the one or more concentrations, the properties, or a combination thereof of the one or more individual chemicals; and
outputting a second regulatory output.

30. The method of claim 1, the method further comprising:
accessing a tag of the regulatory output;
applying the rules of the specified regulatory authority; and
outputting a second regulatory output.

31. The method of claim 30, wherein the second regulatory output includes a change in language, an updated rule, or a new jurisdiction.

32. The method of claim 29, wherein the tag is a barcode, QR code, RFID tag, or a combination thereof.

33. (canceled)

34. The method of claim 1, wherein applying the predefined steps of the algorithm comprises:
analyzing the enriched properties of the one or more individual chemicals;
analyzing interactions of the enriched properties; and
defining the representative properties based on the interactions of the enriched properties.

35. The method of claim 1, wherein applying the predefined steps of the available algorithm comprises:
acquiring data regarding the one or more chemicals from the at least one data source;
evaluating the data from the at least one data source using a Rete algorithm, a conditional algorithm, a decision tree, one or more machine learning algorithms, one or more treat algorithms, a leaps algorithm, a Gator network, or a combination thereof to define enriched properties;
outputting raw data in a raw format; and
submitting the enriched properties to an output.

36-41. (canceled)

42. A non-transitory computer readable storage medium storing instructions that, when executed by one or more computers, cause the one or more computers to:
receive one or more identifiers of one or more individual chemicals;
receive one or more concentrations of one or more individual chemicals into an algorithm;
enrich properties of the one or more individual chemicals by obtaining properties of the one or more individual chemicals from at least one data source to generate enriched properties;
evaluate the enriched properties of the one or more individual chemicals to define representative properties of the one or more individual chemicals by applying the predefined steps of the algorithm; and
define a regulatory output of the one or more individual chemicals based on the representative properties.

43-78. (canceled)
